(19) United States
(12) Patent Application Publication
(10) Pub. No.: US 2011/0220373 A1
(43) Pub. Date: Sep. 15, 2011

(54) Soil Aerator Tandem Roller Frame

(76) Inventor: James R. Martindale, (US)

(21) Appl. No.: 13/134,003

(22) Filed: Dec. 8, 2007

(51) Int. Cl. A01B 45/02; A01B 61/00; A01B 49/04; A01B 21/00

(52) U.S. Cl. 172/21; 172/261; 172/27; 172/600

(57) ABSTRACT

This tillage machine design utilizes the patented aerator tine by Martindale (U.S. Pat. No. 6,854,525). It is disclosed here in a series of different arrangements within machine frame designs. These frame design protocols protect the farmer from maintenance neglect and unintentional misuse of the tine technology which can lead to inconsistent performance. These designs result in greatly reduced costs of soil-engaging tines. The range of power requirements and concomitant degree of soil fracturing in relation to the number of tine perforations is achieved while enhancing soil erosion control potential. The frame design also embraces two additional technologies for crop residue re-sizing and secondary tillage, creating a one-pass total tillage machine for forage crops, vineyards, orchards, pastureland and row-crop production systems. The machine designs disclosed require less framing steel and ballasting requirements for soil penetration thus extending life of all component parts such as bearings.

The description of this tillage tool invention discloses several arrangements of framing members and associated moveable components attached thereto which selectively reduce soil bulk density while significantly reducing soil erosion potential by eliminating vertical mixing of soil. This disclosure is totally dependent up on the use of the aerator tine disclosed in U.S. Pat. No. 6,854,525 Canadian Patent# 2,409,097 (Martindale 2005) in achieving the goals of vertical tillage.

The invention disclosed permits an infinite range of tillage actions and tine alignment configurations to achieve a wide range of tillage functions. Attachments to the frame invention disclosed include choppers and rotary harrows which when properly adjusted achieve unique benefits ranging from gentle cultivation of existing crops to residue resizing and thorough secondary tillage mixing to depths of up to three inches without inverting the soil profile while providing soil fracturing to the full depth of the plow-layer or about nine (9) inches.

The invention described achieves the goal of water transport and air exchange without destroying the fragile eco-system of agricultural soils. As a direct result this invention provides a coherent set of tillage technologies which will increase agricultural soil health and inherent productivity.

### BACKGROUND

1. Field of the Invention

Tillage practices world wide have undergone significant changes during the decades following the 1960's when moldboard plowing and other serious soil inverting tools were commonplace. Significant progress in planting equipment has ushered in a plethora of new tillage concept tools many of which are now termed “vertical tillage” machines. Many of these machines do not address soil structural difficulties due to weathering or traffic compaction forces because they are unable to successfully operate at the depth of the normal plow-layer or 7 to 9 inches deep.

The machine disclosed here disrupts compacted soils according to a regular pattern which is effective at restoring water and air exchange throughout the entire plow-layer. No zones of compacted soil remain sufficient to produce areas of water-logging.

The machine invention disclosed produces significantly increased reduction in soil bulk density so that the attachments proposed in this disclosure function in a uniquely superior way. They enter the plow-layer at controllable depths to achieve several heretofore unobtainable results. This is achieved by changing the aerator portion of the tool to alter the amount of soil bulk density reduction. For example, rotary harrows have historically been used to till only enough (1″ or less) to be able to lift plant residues from wet soil surfaces to allow air to dry the field surface enough to be able to plant without mud accumulating on the planter parts. The rotary harrow when operated in conjunction with this invention can cultivate shallow weeds in wheat and alfalfa or produce a homogenous seedbed up to three inches deep in a single pass.

In sum the invention disclosed here is a primary tillage device coupled with secondary tillage tools offering a wide range of applications heretofore not achievable in one pass or multiple passes. The machine described in this disclosure does not claim to transport any soil from within the plow-layer to the soil surface to create such a seedbed condition. Therefore these combined technologies achieve the goals of no-till concepts with regard to root system and surface residue management while reducing soil bulk density to produce plant root systems characteristics equal to or better than those achieved using conventional tillage techniques without the risk of soil erosion due to wind or water.

2. Description of Related Art

Soil aerator machines have been plagued by requirements for high amounts of weight in framing components and ballasting. This requirement has been met by including large amounts of structural steel in the framing of the machine or by adding ballasting materials such as water or concrete to the machine frame. In any of these scenarios the need to add pounds to the tine to achieve entry and complete penetration has required use of more expensive bearings and additional framing materials in order to transmit the force required during field operations. It has aggravated tine, roller, tine retaining bolt, bearing and frame failure. Transport of the machines is complicated because the transport wheels, axles and bearings must be sized to safely transport these large loads required for penetration in the field. The situation is even more aggravated in the case of folding models. Some machines require sophisticated weight trays and brackets in order to secure the ballast to wings, which fold vertically. The increased sizing and expense of the hydraulic components required to control these wings adds considerably to the cost of this technology. Large wing loads raised high above the transport system has produced dangerous highway accident potential.

One of the primary reasons for needing to create combined frame weights over 700 pounds per foot of machine width is because of the number of tine entry events which occur at any single moment in time across the machine width and the commensurate point pressure required to achieve complete tine or projectile penetration into the soil.

An additional limitation of existing soil aerator technology has been the total amount of soil fracturing achievable in a single pass of the machine. Operator guidelines in the case of the Mayer (1988) art suggest making two passes over a field in opposite or perpendicular directions to achieve more tillage. In excessively hard soil conditions due to vehicular traffic or by virtue of the nature of the soils themselves, multiple passes have been required to obtain sufficient amounts of loosened soil in order to facilitate planter or seeder operation. Additionally, more tillage is often required in order to obtain adequate root mass development. This is especially true when establishing a new crop with a bare soil condition. Additional field passes quite literally double or triple the cost of operation of this technology.

Attempts to create more total soil tillage have resulted in designs which are not suitable for aeration procedures in hay crop forages or other perennial living cultivars. These inventions achieve more tillage by misalignment of two tandem-mounted rotating tine assemblies. Two roller assemblies are mounted integrally on the same swingarm assembly to force the rear gang tines to till between the initial row of perforations (Holland Equipment LTD, Canada). This serves to increase the ballasting requirement for the total machine as well as double the number of soil perforations. This predisposes the soil to greater potential for erosion by dislodging more root mass from the plow layer. This arrangement hinders soil surface conformity during operation especially at greater roller offset angles which are required to produce more loosened soil. In these situations the tillage is too destructive for stimulating existing root systems except to kill the plant. The same problem exists when attempting to operate in young row-crops such as corn and grain sorghum as a cultivator. Now the farmer is faced with having to own two different machines or one must disassemble components to make the tandem configuration suitable for the full range of applications.

Mayer (1988) argued that the tine alterations on the Huxford (1983) tine achieved the goals of aeration without surface disturbance plus overturned soil when adjusted to a greater angle of offset to the perpendicular to travel direction. This it achieved, however, at the expense of producing residual zones of tine operation induced compaction.

The existing art to create more loosened soil has been in part an attempt to enable operation of light-weight secondary tillage tools which need more loose soil in order to perform properly. These practitioners realized this could not be achieved with a single rank 7.5″ spacing machine; hence, the tandem configuration from Holland Equipment LTD. which is described above. Ironically the additional soil fracturing from these efforts created the need for secondary tillage. The surface was still too inhospitable for planting and harvesting machines without using additional secondary tillage. Secondary tillage tools used in conjunction with other presentations of the tine-type soil aerator are engaged in primarily breaking and redistributing soil which has been moved upward from within the plow-layer to the field surface (Mayer 1988). The secondary tillage has, in fact, been employed to refill the depressions or holes made by the aggressive action of the aerator tine. The situation presented to the end user here then is no different in net effect from other conventional tillage soil eco-system destroyers.

One of the limitations of the aeration tools offered in the marketplace today has been the inability of the operator to consistently and reliably replace soil engaging tines to maintain optimal performance. Optimal performance is primarily determined by the depth of penetration of the soil engaging tine device. That is obviously a function of tine length and the ability of the tine to penetrate to its full length. There is always the question of “How deep does the tine need to be in order to be effective?” Diagnosing the soil condition to determine the correct answer to that question is quite sophisticated. It can require the knowledgeable operation of a soil penetrometer or other much more sophisticated measurement devices not readily available on the farm or other work site. The lack of sophistication in machine design has continued to make demands on operator knowledge and skill development which have gone largely unmet. In addition to problems of inadequate diagnostic skills to know when tines need to be replaced, tine costs continue to rise so there has been an ever-increasing need to reduce cost of operation. Owners of this technology who have failed to make these maintenance expenditures for tine replacement for whatever reason have not been able to achieve the benefits which this technology does provide when properly maintained and operated.

The original tine design by Huxford (1983) and enhancements by Martindale (2005) tine is clearly the only tine design which creates no residual compaction and produces the greatest reduction in soil bulk density. However, the issue that has remained unaddressed to date is that of creating enough total tillage per unit of square area in one pass to provide a uniform seedbed for proper planter/seeder operation and uniform plant rooting characteristics while maintaining no-till residue and sustainable soil management objectives.

More marginal soils, which are often used as grazing lands or for the production of hay crop forages are often troublesome because of the presence of field stones or rocks. If these rocks are displaced to the field surface, then mowing and other harvesting operations are nearly impossible except at great expense. These troublesome soils are some of the potentially most productive soils in use today and need to continue to be into the future. Previous and present renderings of this tine-type technology have placed approximately 69,000 perforations per square acre. This number of insertions by simple probability disturbs more root systems and finds more rocks in routine operation than a design which produces fewer perforations. This prior art of the technology has not been user friendly in these less than ideal soil conditions to the present time. Single rank renderings of the aerator requiring greater angles roller offset only further aggravate the rock problem.

In addition, existing soil aerator machines do not permit adjustability while the machine is underway performing soil tillage. Adjustability has historically been a constant compromise from one soil type or field condition to another, even from one end of a field to the other. Many agricultural field situations present as many as two to three different soil conditions and/or soil types in a single trip through the length of a field. In certain moisture, crop conditions and soil types it is advisable to change tine aggressiveness much more often than is practical with existing technology.

### DESCRIPTION OF DRAWINGS

FIG. 1: Typical tillage pattern for single or double offset tandem frame designs using 6-ring roller assemblies with a 40 degree helix. Roller offset six degrees from perpendicular to direction of travel using preferred helix protocol from FIG. 11.

FIG. 2: Typical tillage pattern for single or double offset tandem frame designs using 3-ring roller assemblies with a 40 degree helix. Also offset at six degrees from roller perpendicular to travel direction.

FIG. 3: Single offset roller arrangement in a single wing fold machine frame. Preferred embodiment for folding frame since thrust does not create lifting force at the hinge point.

FIG. 4: A rigid frame embodiment of the tandem roller frame using double-offset roller assemblies for more consistent tracking on hilly terrain. Swingarms are offset counterclockwise and/or clockwise relative to perpendicular of travel direction.

FIG. 5: A single offset tandem embodiment with castering front transport wheels to permit floating hitch for best possible terrain following characteristics. Embodiment includes use of cam-shaped swingarm adjusters for infinite angle adjustment powered by hydraulic, manual or electrical actuators and roller offset angle indicators for differentially adjustable front and rear roller assemblies.

FIG. 6: An embodiment using single offset tandem configuration with fixed pin swingarm retaining protocol allowing counterclockwise and clockwise adjustment of the swingarms relative to the perpendicular of travel direction.

FIG. 7: The preferred embodiment combining the action of the rotary harrow by Phillips and the tandem frame protocol. Harrow sub-frame permits easily adjustable offset angle.

FIG. 8: This embodiment of the tandem frame includes attaching a rotary chopper on the front of the main frame. The attachment is interchangeable to a rear mounting.

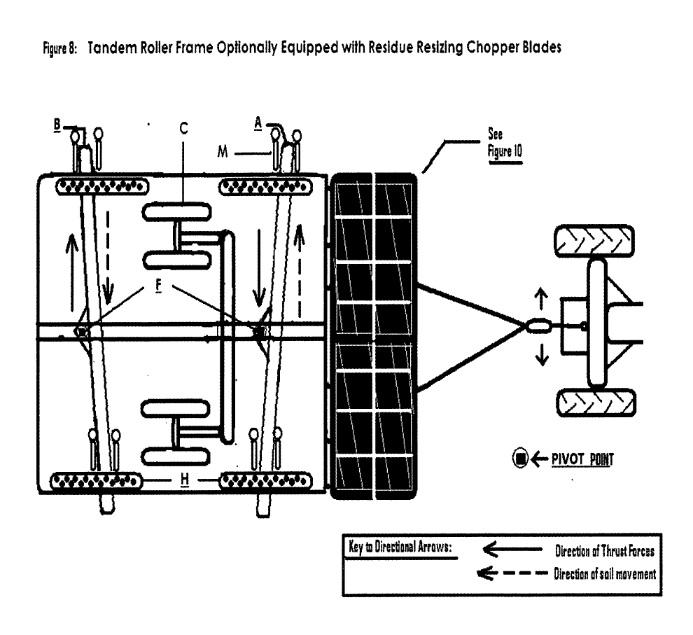

FIG. 9: This embodiment attaches both rotary harrow and residue choppers for resizing plant residues and even distribution.

FIG. 10: MacFarland stalk chopper assembly courtesy of MacFarland Mfg. Inc.

FIG. 11: Preferred embodiment of a six-ring roller assembly using two phases in a—clockwise helix. The helical tine locations are necessary in order to engage intersecting 45 degree chevron patterns in the soil to achieve the design features of this machine invention illustrated in FIGS. 1 and 2.

### DESCRIPTION OF PREFERRED EMBODIMENTS

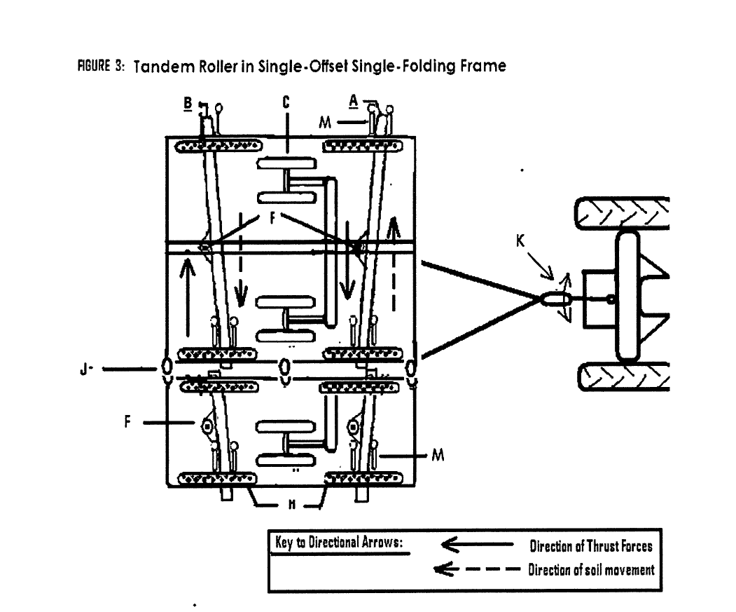

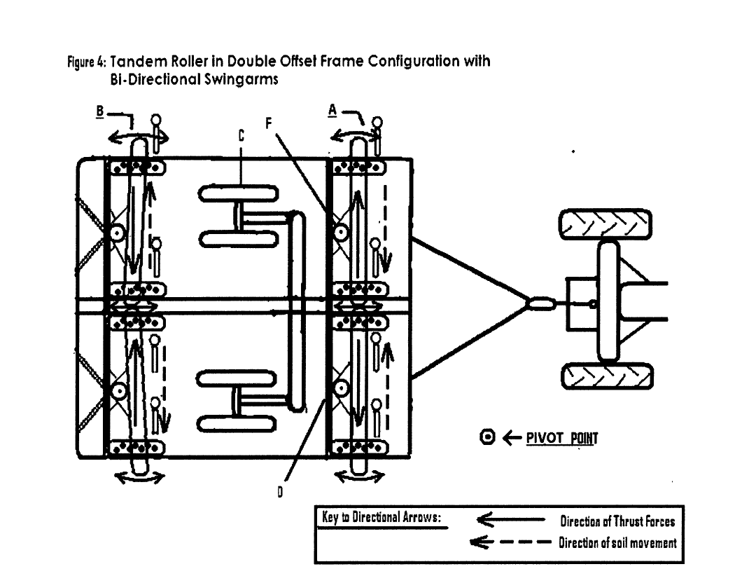

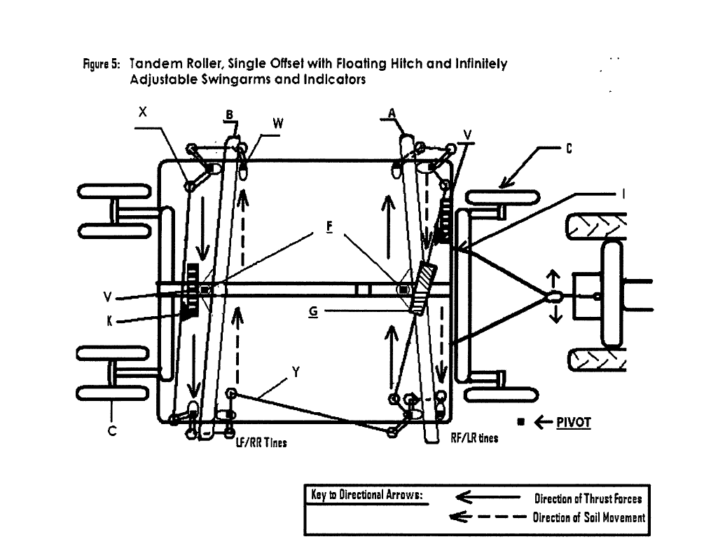

The basic framing invention presented here resembles that of the traditional tandem (double-offset) or single-offset disc frames, where gangs of soil engaging tooling are organized into a front and rear set of soil engaging devices or tooling (FIG. 3 & FIG. 4). Framing components can be supported for transport by mid-mounted (FIG. 3-C) or castering (FIG. 5-C) and rear mounted transport wheel systems. Mid-mounted transport wheels require the use of flexible leveling linkage systems to achieve adequate ground-following characteristics. The latter of these embodiments (FIG. 5) discloses a floating hitch (FIG. 5-I) for the ultimate in soil surface conformity.

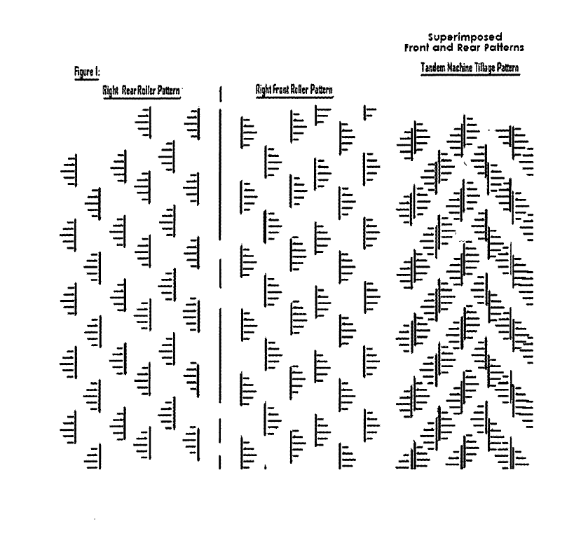

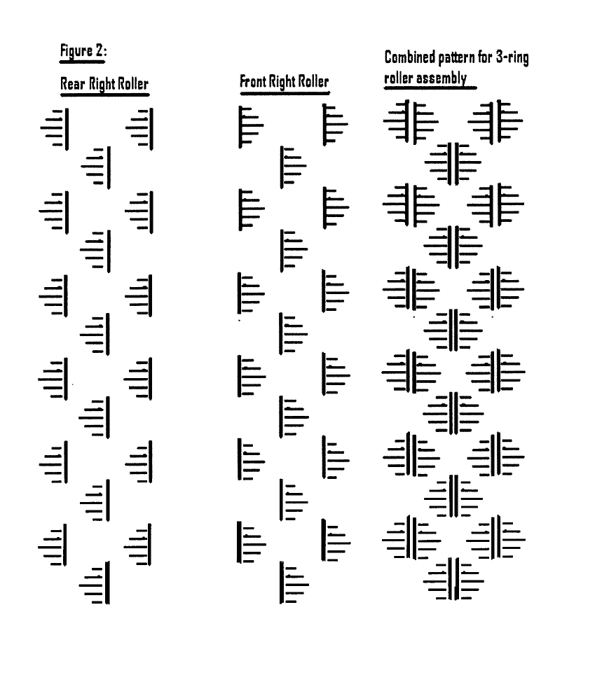

The main framing members are arranged to securely fasten swingarm assemblies (FIGS. 3, A & B) so that they can be adjusted laterally (side to side) in the framing. (FIG. 4-D) The swingarms are also rotatable around a point at or near the center of the swingarm (FIG. 3-F) so that it can be offset from the perpendicular to the direction of travel in either direction, in other words, clockwise or counter-clockwise around the pivot point (FIGS. 5-F & 6-F). The departure from disc and other aerator frame designs (Mayer-assigned to Holland Hitch LTD.), which is unique to this invention, is that the tine penetration locations are optionally and preferred to be in the same locations for the front and rear roller assemblies of this invention (FIG. 1 FIG. 2). These assemblies can also achieve other tillage and/or fertilization patterns by selecting alternative mounting locations of the swingarm pivot assembly by laterally repositioning of the swingarm pivot locations. (FIGS. 4-F, 5-F and 6-F)

This frame embodiment, by placing roller/tine assemblies several feet apart, is able to follow field surface irregularities. The transport wheel assemblies located between the roller/tine assemblies are placed so as to provide weight transfer to the tractor drawbar for safe transport operation. (FIGS. 3-C, 4-C, 6-C, 7-C, 8-C, 9-C) Under normal field operations the transport wheels are raised to a position which causes the tires to be above the soil surface sufficiently to permit the roller assemblies to consistently follow surface irregularities.

### Tillage Enhancement

This invention recognizes and takes unique advantage of the soil fracturing actions performed by the Huxford and Martindale (U.S. Pat. No. 6,854,525 Canadian Patent# 2,409,097) inventions. This tine action is definable as a two-step process. The first step is the perforation or entry made into the soil. The amount of force required to penetrate the soil is directly proportional to the number of perforations performed per foot of machine width. The tandem invention in net effect achieves a greater range of total soil fracturing. This is achieved by increasing the tine-set spacings to greater than 7.5 inches, thereby reducing the number of insertion locations per acre. Greater total soil fracturing is achieved by using the same insertion location a second time and applying force in the opposite direction from the initial insertion location (FIG. 1 and FIG. 2). Single rank machines (Mayer et. al.) cannot exceed 7 to 8 inch spacings because of the normal fracture lines associated with lateral thrust of the tine. The number of perforations per acre is approximately 48,250 in the three-tine per ring assembly protocol in this tandem embodiment using a 10 inch tine set spacing (FIGS. 1 and 2). By comparison the number of insertions per acre required by Mayer is nearly 70,000 using the 4-tine roller configuration. The effect of this invention is to reduce the weight requirement for tine entry in any given soil situation by nearly 30% for a given frame width.

Step two, subsequent to initial perforation and continuing through final insertion depth, the tine geometry, when optionally combined with roller assembly angle offsetting (FIGS. 3-A—front gang and 3-B—rear gang), exerts lateral forces to create fracture lines in the plow layer. In a single rank machine these two operations must be achieved to the desired degree in one single action and as such produce excessive strain on tines, bearings and framing components. In order to achieve these two fundamental requirements, this invention optimizes second and final perforation at the rear gang (FIG. 3-B) of the tandem system so that the insertions are consistently as deep as possible (full tine length). This is achievable because less wear occurs on rear tines. Thrust loading of the bearings and framing members throughout in this invention are dramatically reduced when compared to a single rank (or repetition) design. The consistency of soil penetration depth is necessary in order to remove compaction forces and weathering effects (or silt density layers), thus creating maximum water retention capacity, air exchange as deep as possible in the soil profile and achieve maximum rooting depth potential and lateral proliferation. This invention, unlike other attempts to create more loosened soil, does not sacrifice existing rooting development to create soil fracturing.

This roller configuration and frame embodiment, in recognition of this two-step process, creates heretofore impossible reductions in the cost of operation by increasing the life of service parts such as replacement tines when compared to single-rank embodiments. The rear mounted tines (FIG. 1-A and FIG. 2-A) which operate in the pre-formed holes (produced by the forward tine assemblies) (FIG. 1-B and FIG. 2-B) experience drastically reduced wear rates. This prolonged period of service life of the rear roller assemblies assures consistently deep penetration and assures fracturing of at least one side of the perforation at all times. The front set of tines, when worn to one-half or less of their original length, continue to perform the initial hole-opening process long after the single rank machine would have required tine replacements in order to still have effective depth of tine penetration. The direct result then is to preserve the rear tine length for prolonged effectiveness and extended total acreage potential for each tine pro rata.

### Roller Assembly Interchange

When scheduling and other conditions permit, the rear roller assemblies (FIG. 4-B) can be quickly detached and interchanged or relocated to the front frame position (FIG. 4.-A) and vice versa and worn tines are then replaced on rollers that were operating at the front of the frame.

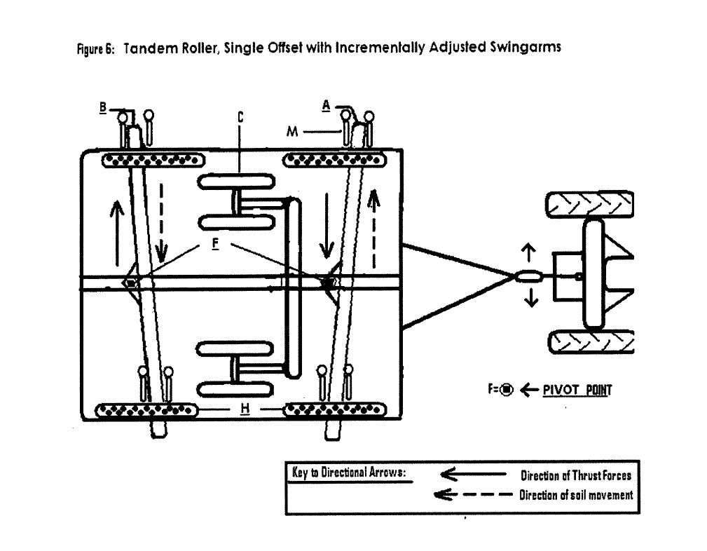

The double-offset design frame (FIG. 4) would require diagonal relocation of the roller assemblies (FIG. 4) if the roller offset angles are not reversed. If the swingarms are permitted to be repositioned to the opposite offset angles, then the tine/roller assemblies can be moved directly forward on the same side of the machine frame (FIG. 5 and FIG. 6). This frame invention permits forward offset embodiment either front or rear so that optimal drafting characteristics are achievable.

The single-offset arrangement requires reversing the swingarm offset (compare FIG. 5 to FIG. 6) and moving the roller assemblies to a forward position toward the tractor. This is when the rear assemblies using RF/LR tines (previously operating in the front of the machine) (see FIG. 5) would be outfitted with new replacement tines and begin their service in the rear of the machine. Since twenty-five percent (25%) fewer tines are used per foot of operating width of the machine compared to other inventions of the tine type aerator (Mayer) this represents a considerable operational cost reduction.

The fracturing forces created by the Huxford/Martindale tine geometry are largely a function of the amount of soil engagement with the body of the tine thrust face. Therefore, the front and rear ranks are individually and independently adjustable to compensate for tine length reduction over time and usage, especially in the front rank of tine/roller assemblies (FIG. 3-A). The independent adjustment of the front assembly offset in adverse conditions is essential to achieve maximum penetration without adding ballast or aggravating breakage.

### Timing the Soil Engaging Tines for Longitudinal Alignment

The Huxford (1983) and Martindale (2004) tine creates unique fracture forces in the soil. These zones of density reduction are utilized in this invention to induce the subsequent tines on the rear roller assemblies to adjust their speed until they are in registration with the preceding tine and roller assembly. No external timing or connecting mechanical devices are required to achieve the registration of the tine perforations between front and rear assemblies (FIGS. 1 & 2).

If field obstacles produce misalignment or if normal lifting and lowering cause misalignment it is quickly remedied once the tines are reintroduced into the soil. The use of 40 degree helix arrangements combined with the operating characteristics of the Huxford and Martindale tines creates a diagonal or chevron soil tillage pattern of 45 degrees. This facilitates the alignment of the tine perforations between the two ranks of roller/tine assemblies since the two patterns of perforations are intersecting diagonals (FIGS. 1 & 2).

By operating with both front and rear gangs in the same tine penetration locations, ballasting is reduced because the initial penetration in the front has served to create the opening for the rear gang tines. Tine entry into a preformed hole reduces entry resistance to near zero. The entry or leading edge of the tine has virtually no abrasive wear except for reaching the full penetration which may not have been fully achieved by the front gang tine set in extremely dry, compacted conditions, or as the front tine is experiencing normal wear prior to replacement.

### Double-Offset Configuration

The roller gangs are offset in opposite directions perpendicular to the direction of travel of the machine from zero to 10 degrees (FIG. 4). Typically the front gang is offset with the outer end of the gang moving forward in the direction of forward travel (FIG. 4-A). This can be reversed with good effect, however, it may require additional ballasting to achieve equal penetration. The rear gang assembly is offset in the opposite direction. The tine action is alternately to the right-hand or to the left-hand side of the machine from the insertion hole (FIGS. 1 & 2).

### Single-Offset Arrangement of Roller Assemblies

Arrangements of roller assemblies in a single-offset pattern achieve the same benefits as tandem double-offset arrangements plus one additional significant benefit. The double-offset roller arrangement creates horizontal thrust forces either in the front or rear of the machine depending on which roller set is offset forward. Frames for large sizes which require folding hinges (FIG. 3-J) for transport between field locations translate the horizontal thrust from wing assemblies into vertical lift forces at the hinge. This results in the frame and attached soil engaging apparatus being unable to follow soil surface contours for uniform penetration of the plow-layer by the tine.

By creating single-offset geometry (FIG. 3-A and B) the thrust forces in the front and rear of the frame are self-canceling. This also permits unpinning of the tractor drawbar (FIG. 3-K) which provides an additional safeguard for soil engaging members in rocky soil conditions.

Interchangeability of tines from rear to front roller assemblies and vice versa is achieved by reversing the angle of offset of the roller swingarms. Compare swingarm positions in FIGS. 5 and 6. This provision in swingarm mounting within the framework of the machine means tines do not need to be dismounted to be moved to the new location for continued service. The entire roller assembly is removed and remounted in the suspension system at the forward end of the machine frame. The swingarm offset angle is then reversed and ready for service again.

Common Elements of Single Vs. Double-Offset Configurations

### Tine Spacing

The tine spacings which are normally seven (7) to eight (8) inches apart are increased in this rendering of the roller assembly to 10 or more inches, from tine center to tine center. There are obvious benefits to this since most row crop seeding equipment is spaced at 30″, 20″ or 10″ (for cereal crops). The operation of the tine (Huxford and Martindale) is adjusted to leave all soil in the hole created by the two tines and seeding accuracy in terms of seed depth placement is unaffected. The weight requirement is directly proportional to the number of tines entering the soil per unit of width of the machine.

These considerations equate to several machine design enhancements. A typical roller design at 7.5″ tine spacings would till approximately 45″ in width. This roller would typically consist of 6 rings or hubs of tines. This is one of several optimal tine patterns. Using the same number of tine hubs per roller shaft, for example six, (which results in equal thrust forces), a ten-inch spacing effectively tills 60 inches instead of 45 inches. This represents a reduction of 33.3% in the total weight required to effectively till the same width of soil surface. Additionally, this increased amount of tillage for equal ballasting achieves full width fracturing in the tandem roller configuration by displacing soil five inches to the side of the tines (FIG. 1, FIG. 2), whereas the single gang concept would require fracturing soil a distance of 7.5″ from the tine. This difference is significant because it equates to less total lateral movement of the tine in the soil. The greater the reduction of the lateral movement of the tine the greater is the increase in service life of the tine, roller suspension system and bearing service life because of the reduced thrust generated by the tine operation.

This tine spacing also results in very practical machine widths in multiples of five or ten feet. By combining the 60″ roller width with 30″ roller widths it is possible to achieve operating and transport widths in increments of 5 feet for the double offset configuration. Machine width intervals in the single-offset configuration is as small as 2.5′. These roller assembly dimensions are conceived to present a 45 degree chevron pattern in the soil surface which provides optimal tine registration or alignment between front and rear assemblies. (FIGS. 1, 2, and 11)

### Helical Tine Patterning

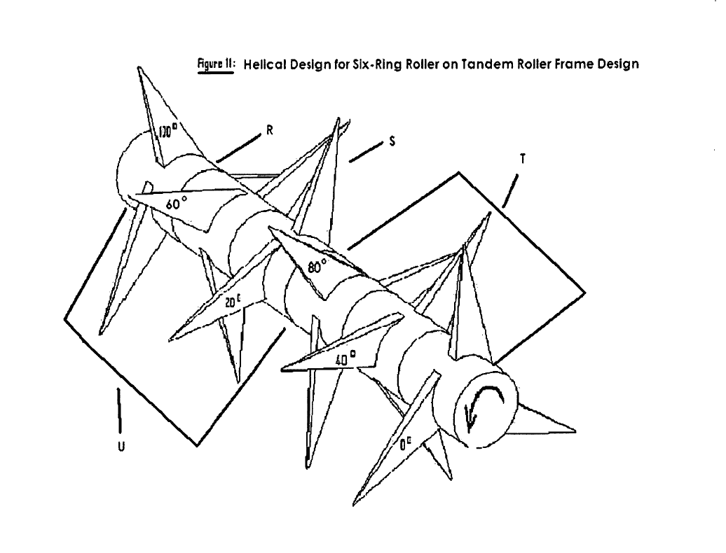

One of the key elements to the satisfactory performance of the tandem design soil aerator is the creation of tine locations on the roller assembly (FIG. 11-R) so that perforation alignment is accomplished longitudinally. The nature of the operation of the Huxford (1983) and Martindale (2005) patented tine designs dictates the helical tine locations for proper performance. The speed of the roller shaft is such that the resulting pattern in the soil surface from the operation of this particular helix of forty (40) degrees results in a diagonal or chevron of forty-five (45) degrees. This is ideal for intersecting the primary set of perforations (FIG. 1) with that of the second set of tines in the rear roller assemblies.

With three tines per grouping the resulting 120 degree radial interval must be partitioned to create a uniform interval between all tines (FIG. 11-S) in all groups of three (FIG. 11-U and T) on the length of the roller assembly. This prevents vibration and irregular penetration performance. This interval is 40 degrees. (See FIG. 11) This is also significant because the soil which is displaced must not be restrained in its lateral movement by the back side of the preceding adjacent tine. The trapping of soil and root systems in this way will produce a lifting action as the tine exits the soil profile during the last ninety (90) degrees of tine engagement in the soil.

This arrangement is achieved with a grouping of three sets of three tines each. (FIG. 2-T and FIG. 2-U) However, the use of six groups of three tines each presents an additional challenge (FIG. 2). If the helix continues at the 40 degree interval throughout the tine groupings to the fourth grouping, the first and fourth groups are forming perforations at the same time. The resulting weight available for producing penetration of the tine is reduced by fifty percent (50%).

The second grouping (FIG. 11-U) of three sets of tines (FIG. 11-S) consisting of three tines in each set is therefore offset as a group by twenty (20) degrees from the first group of three sets of tines. (FIG. 11-T) The direction of the offset is critical for proper performance according to criteria given above. If the roller assembly is to be offset so that the outer end of the roller is moved forward (counter-clockwise) toward the prime mover then the helix begins at the outer end of the roller and is directed counter-clockwise in forty (40) degree intervals. The second grouping of three set of tines is further set twenty (20) degrees behind or counter-clockwise from the first grouping of three sets. If the roller outboard end is offset to the rear of the machine frame (clockwise), then the helical pattern commences at the center-line of the machine frame and is directed in forty (40) degree intervals in a clockwise direction. Similarly the second grouping follows the primary group by twenty (20) degrees in a clockwise direction. (FIG. 11-T, U)

The net effect of this arrangement creates uniform entry intervals of twenty (20) degrees so the operation is without vibration. This also maintains a minimum of forty (40) degrees between adjacent tines to prevent soil lifting during tine exit phase. It is impossible to achieve tine perforation alignment via roller speed adjustment in the absence of this helical pattern.

### Center-Pivoting Swingarm/Tine Assemblies

Previous art has historically pivoted swingarm assemblies from near one end of the assembly. This invention, using a center pivot for the swingarm assembly (FIG. 5-F), results in less required radial movement of the swingarm to achieve any desired amount of offsetting. This permits greater latitude and space for positioning transport tires and associated apparatus within the framing. This center-pivot system also facilitates integration of larger diameter pivoting hardware to resist wear associated with thrust loads applied to the swingarm by the tines during operation.

Although FIG. 5 illustrates use of four (4) cam-shaped devices (FIG. 5-W) to reposition and hold the individual swingarm assembly, it is optionally possible to achieve the same results using only two cams, each located on the same side of the swingarm face. The mechanical turnbuckle or electrical/hydraulic actuator (FIG. 5-G) is fastened to the machine frame to operate the cams.

This arrangement for offsetting the pivot point (FIGS. 4-F, 5-F, 6-F, 7-F, 8-F and 9-F) swingarms makes positioning of roller suspension components much less complicated and assures alignment of insertions laterally at any roller assembly offset angle. The strength needed at the swingarm attaching point area for the suspension components is in no way compromised by welding or drilling procedures to create the pivot point.

The option to reposition the pivot (FIG. 5-F to 6-F and 4-F) to offset or misalign tine perforations between the front and rear assemblies is also now possible. This repositioning is also useful if double-offset assemblies are reversed so that the tillage pattern at the machine frame center is not ridged or left untilled (FIG. 4). The mounting framework is outfitted with a series of holes or other such devices for securing the pivot anchor to the machine framework.

By using the center pivot arrangement it is a matter of using spring-loaded or hydraulic cylinders with closed center tractor systems or accumulators to integrally provide for roller/tine assembly lateral movement around imbedded obstacles in the soil. By mechanical adjustment or hydraulic pressure adjustment it would be possible to accommodate a wide range of field conditions without suffering broken tines or premature bearing failure. These embodiments would be apparent to a person skilled in the art.

### Creating Tillage Zones

Adjustable locations within the framework of the roller pivot points in this invention is used to create tilled zones and alternating untilled zones within the same operating range. This would be similar to what is achieved by using knives in what has been popularized as “strip-till”. The current interest in twin-row planting configurations (7-8″ double rows on 30″ centers) is especially compatible with the tandem tine operation, in either double-offset or single-offset. The frame invention presented here permits both operational modes. Planting single rows between two rows of tines can be achieved on 10″, 20″ or 30″ spacing. Twin-row planting can be achieved when tine slots front and rear are coincident. Planting single rows can be configured between twin rows of tines where additional soil perforations are desired and erosion is not an issue. Under high erosion potential conditions selected groups of tines can be removed to leave larger untilled zones.

### Visual Indicator of Degree of Soil Fracturing

Cam operated swingarm adjusters (FIG. 5-W) are optionally outfitted with an indicator to clearly depict the relative amount of roller offset. This indicator (FIG. 5-V) is attached to connecting linkage (FIG. 5-X) which when operated moves laterally across the machine frame. A scale is attached to the frame in a fixed location to indicate changes in the swingarm offsetting position. This device is duplicated in the rear and front of the machine to indicate offsetting angle of the roller assemblies independently from each other.

### Multiple Roller Installations on a Single Swingarm

Another distinct advantage of the tine spacing of ten inches is that multiple roller assemblies can be installed continuously (end to end) on the same mounting or swingarm. Narrower tine spacing does not allow sufficient allowance for bearing and retaining hardware on the ends of two or more adjacent roller assemblies. Locating bearings internally on the roller shaft, which leaves one hub unsupported at the outer end of the shaft results in serious potential shaft failure due to bending (Mayer-1988).

### Swingarm Adjusting and Retaining Systems

Historically the renderings of adjustable swingarm soil aerators have used fixed locations at 2.5 degrees of offset from the perpendicular to travel direction. The tandem roller invention presented here creates so much additional tillage (FIGS. 1 and 2) that it is not possible to sufficiently control the final results of aeration and/or combined rotary harrow operational depth using this prior established art. This invention presents a fixed position that is in 1 degree increments (FIG. 6) using a locating pin (FIG. 6-M) and hole system. The invention also presents a cam system (FIG. 5-W) which is infinitely adjustable from 10 degrees clockwise to the perpendicular of travel direction to 10 degrees in the counter-clockwise to direction of the perpendicular to the travel direction. The connecting linkages (FIG. 5-X) shown in this embodiment are powered by a mechanical turnbuckle device or remotely by electrical or hydraulic actuator (FIG. 5-G). The same cam which locates the swingarm is also used to retain the swingarm offset angle by fixing the actuator to a stationary frame member. By adjusting linkage (FIG. 5-Y) between the front and rear swingarm assemblies, a differential can be maintained between the front and rear assemblies through out the adjusting range.

It is particularly significant that these adjusting embodiments do not serve to restrain the swingarm assembly from lateral movement in the machine frame. This provision is essential for relief features described above and for lateral alignment/misalignment according to operator preferences.

### Other Benefits in Arid and Semi-Arid Climates

Operation of soil aerators during hot and/or dry season conditions where irrigation is not available is very risky. If it fails to rain as hoped, the opening of the soil in approximately 69,000 locations per acre for (Mayer 1988) can cause additional drought stress due to evaporative loss. The action of the tine will invariably cause capillary water to migrate upward. This represents potentially sacrificed moisture content for crop production. A reduction to slightly over 36,000 perforations means significant soil moisture conservation. Achieving additional fracture zones however, greatly increases the rate of water transport or percolation when rainfall events do occur. Lateral adjustment to produce slight misalignment of perforations will further reduce potential evaporative losses also by displacing soil into the initial insertion hole.

### Combining Technologies for Enhanced Performance

### Rotary Harrow Attachment:

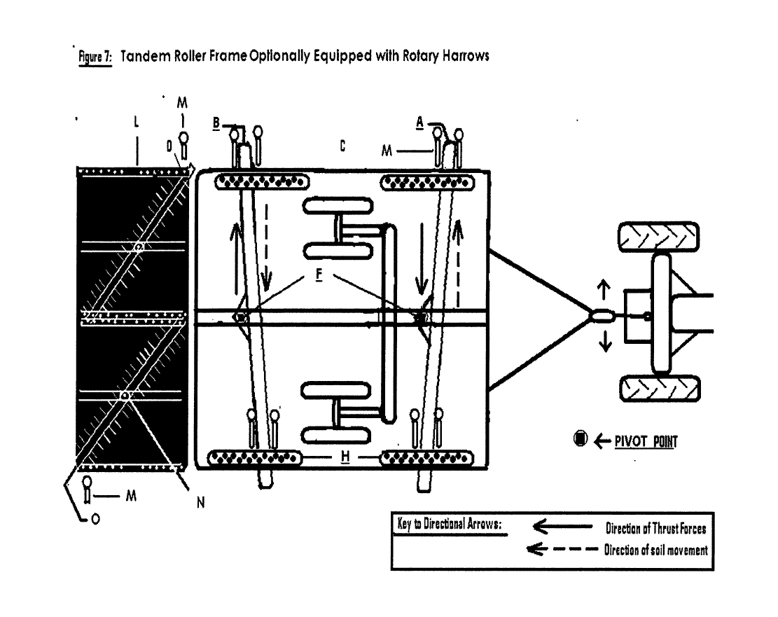

Rotary harrow technology has had serious limitations as presented in the North American marketplace. Typically the best and most often only application has been in extremely wet soil conditions. It has been used to lift plant residue from the soil surface to permit air movement sufficient to dry the soil surface and permit planter operation without accumulation of mud on planter gage wheels. The harrow by Phillips (FIG. 7) because of its unique ability to perform total soil surface disturbance, can perform other additional important functions. It must, however, be able to consistently penetrate the soil surface to depths greater than ½ to ¾ of an inch (which are typical).

The operation of the tandem roller configured soil aerator described herein, is capable of providing the reduction in soil density necessary to permit the rotary harrow to enter the soil profile as much as three inches (or 10 cm) in a single pass at normal soil tillage moistures. This is optimally achieved by not lifting soil from the plow layer to the surface, to then be stirred or manipulated by the harrow tooling. Instead the harrow tooling enters the soil by its own weight because of the amount of total fracturing performed by the preceding operation of the soil aerator tandem tine system. (FIG. 7)

The result of this combined operation is to remove shallow rooted weeds without the use herbicides. By adjusting the amount of soil fracturing performed by the soil aerator tines it is possible to perform full-width cultivation of growing row-crops such as corn and grain sorghum at shallow depths without uprooting the young growing crop and yet remove freshly germinated weed seeds. This combination of technologies has the unique ability of removing weeds from within the row, safely operating between individual desired plants. Alfalfa experiences similar benefits from cultivation after first-cutting removal and again at the end of the harvest season, during the winter or early in the following crop year. This application of the combined technology reduces the need for herbicides.

This combination of tillage has been successfully used to create organic production systems where alfalfa is not destroyed in order to plant the successive row crop such as corn. Mowing or chemical suppression used in combination with this combination of tillage, preplant and again at the V-3 to V-4 stage of corn plant development has produced weed-free, pest-free and nitrogen input free above average yields of corn.

The combined action of the aerator tine and rotary harrow is also very effective at removing shallow depressions in fields caused by loaded wheeled vehicles such as combines, grain carts and trucks. A significant advantage is that the leveling action is most effective in the direction of travel in which the depressions were created. It is not necessary to abuse operator or machinery by crossing these depressions diagonally.

The aerator tine operation causes capillary water to rise vertically along the thrust face of the perforation, so the use of the tine can in certain circumstances aggravates soil moisture conditions for satisfactory planter seed opener operation. The addition of the rotary harrow to the cultivation sequence stops the upward movement of the capillary water at the depth of harrow tooling travel in the soil profile. It is practical to adjust the aerator tine fracture forces to effectively adjust the operating depth of the rotary harrow tooling so that the seed trench is placed in the soil profile right at the point where capillary water concentrates at the bottom of the harrow tooling path laterally through the soil profile.

The use of tillage attachments such as no-till (wavy coulters) is eliminated on planters with these combined tillage operations. The use of residue movers or row-cleaners is advisable in this system since the plant residue material will tend to push into the soft tilled soil and come to rest in the bottom of the seed trench thus inhibiting seed-to-soil contact necessary for uniform emergence.

The rotary harrow attachment embodiment presented here permits the harrow sections to be positioned at varying angles of offset to direction of travel. A swingarm (FIG. 7-O) similar to the aerator roller assembly is employed to retain the harrow framing in the attaching framework. A series of holes located in the retaining framework (FIG. 7-L) is used in conjunction with pins (FIG. 7-M) to select offsetting angles to achieve desired residue placement and soil surface finish. The harrow sections can be rotated about a central pivot point (FIG. 7-N) clockwise and counterclockwise to varying degrees of aggressiveness and residue distribution characteristics.

In conventional chemical farming scenarios, the transport of capillary water vertically in response to the thrusting action of the aerator tine in combination with the rotary harrow action has been used to successfully remove small germinating weed seeds (as above) and simultaneously activate soil applied herbicides by virtue of increasing available capillary water.

### Residue Resizing

With the advent of additional row-crop acres of corn (maize) in North America (for energy independence via ethanol), it is increasingly advisable to add field operations to help increase the rate of corn plant residue recycling. Genetically modified germplasm has aggravated the situation, as well, since this corn stover is more resistant to beneficial insect feeding.

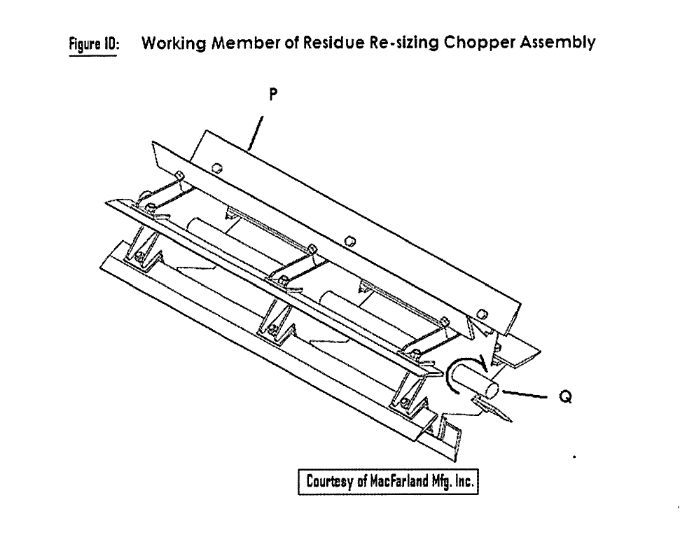

This invention discloses an optionally available and selectable by hydraulic or mechanical turnbuckle type devices a series of blades (FIG. 10-P) mounted in a reel-type device (FIG. 10) fastened to a central shaft (FIG. 10-Q) which retain the blades so that they engage the soil surface while chopping crop residues into approximately six-inch lengths.

Maximizing Benefits with Combinations

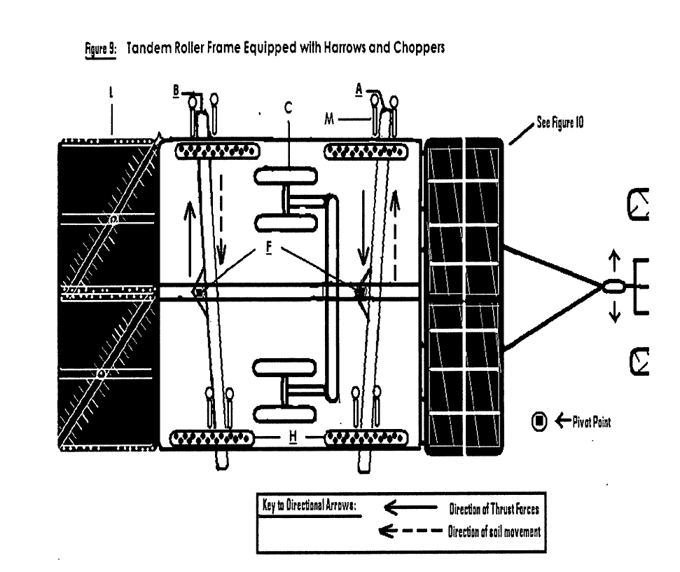

Lastly, by combining all three tillage and residue management technologies (FIG. 9), it is possible to combine other vital best management practices such as covercrop seeding, fertilizing, liming materials application, and applications of other soil amendments such as bio-stimulants and microbial inoculants. Mounting pneumatic and liquid application equipment on or by trailing or tow-between arrangements prescriptive applications with GIS/GPS technologies is a practical reality while performing tillage operations that can tailored to the soil amendments being applied.

The residue resizing technology can be located at the rear of the main frame section to meet specific erosion or other residue management requirements or make the entire frame weight available to enter the front rank aerator tines. All of these best management practices now become part of a single-pass tillage/planting/fertilizing technology which performs necessary primary tillage but does so without destruction of the fragile soil eco-system of beneficial micro-organisms and macro-flora and fauna.

1) A frame which creates extended service life of soil engaging tines by permitting roller/tine assembly interchangeability from rear to front positions and vice versa by relocating within the framework diagonally or laterally

2) A frame which contains double-offset and single-offset tandem arrangements of soil engaging roller and tine assemblies

3) A frame which reduces ballasting and weight requirements for penetration by increasing tine spacing interval to a range of from 7.5 inches up to 12 inches measured laterally between groups of tines on a roller assembly

4) A frame containing roller assemblies which have a 40 degree helical pattern in a clockwise and counter-clockwise rotation for placement in a double-offset configuration rotated clockwise and counterclockwise from the perpendicular to the direction of machine travel

5) A frame containing roller assemblies which have a 40 degree helical pattern in a clockwise and counter-clockwise rotation for placement in a single-offset configuration rotated clockwise or counter-clockwise from the perpendicular to the direction of machine travel

6) A frame containing roller assemblies as described in claims 4 and 5 consisting of six sets of tine groups of three each which are offset clockwise or counter-clockwise to each other by twenty (20) degrees

7) A roller/tine arrangement which provides consistent maximum possible depth of penetration of soil engaging members or tines to assure uniform air/water management results and compaction relief

8) A roller/tine assembly arrangement which automatically synchronizes perforation locations between front and rear roller/tine assemblies

9) A frame containing roller and tine assemblies mounted on swingarms, which are pivoted about a midpoint for purposes of rotation clockwise and counter-clockwise to direction of machine travel

10) A frame containing front and rear ranks of soil engaging assemblies mounted on swingarms which are independently adjustable of each other to offset from 0 to 20 degrees from the perpendicular to the direction of travel from at or near the center position of the swingarm either clockwise or counterclockwise of the perpendicular to direction of travel a total of 20 degrees.

11) A frame containing rotatable cam-shaped assemblies which position swingarm assemblies to infinite degrees of offset clockwise and counterclockwise from the perpendicular to the direction of travel

12) A frame containing swingarm assemblies that are adjusted laterally within the framework to create varying zone widths of tillage and no-tillage

13) A frame containing a swingarm center pivot which when adjustably located in the main frame eliminates ridging or an untilled zone at the machine centerline

14) A machine frame which utilizes spring-loaded or hydraulically-loaded, via closed-center hydraulic system actuators, provisions for the swingarm center pivots to move laterally when encountering an immovable obstacle in the soil

15) A frame which reduces the total number of perforations by 40% or more per roller/tine assembly revolution while producing soil fracturing forces compared to the number of perforations by nearly 200%

16) A frame which is optionally equipped to resize crop residues in front or rear of the center frame segment which, can be engaged or disengaged with the soil surface using hydraulic or manual devices

16) A frame which can be optionally equipped with rotary harrows to provide varying degrees of soil penetration based on its response to density relief produced by the preceding soil aeration tine action

17) A frame mounting for rotary harrows permitting adjustable angles of offset to suit different requirements for residue movement and seed and/or soil applied materials incorporation which can be hydraulically alternately engaged or disengaged with the soil surface.

18) A mounting system for rotary harrows which permits rotation around a pivoting point to obtain offsets to the perpendicular to travel direction from 0 degrees to 45 degrees clockwise or counter clockwise about the center located pivot point

19) A rotary harrow which can concentrate capillary water at adjustable depths when operated in tandem with soil aerator tines used in this invention (Martindale—U.S. Pat. No. 6,854,525 Canadian Patent# 2,409,097)
